(19) United States
(12) Patent Application Publication
(10) Pub. No.: US 2019/0295143 A1
(43) Pub. Date: Sep. 26, 2019

(54) Sale Price Matching

(71) Applicants: Keane Ng, Renton, WA (US); Mike Chaffee, Kirkland, WA (US)

(72) Inventors: Keane Ng, Renton, WA (US); Mike Chaffee, Kirkland, WA (US)

(21) Appl. No.: 15/934,977

(22) Filed: Mar. 24, 2018

(51) Int. Cl. G06Q 30/06; G06Q 30/02

(52) U.S. Cl. CPC G06Q 30/0611; G06Q 30/0282; G06Q 30/0627

(57) ABSTRACT

Disclosed, among other things, is sales price matching, which may enable a buyer to enter search criteria for a product at a desired price and receive a notification when a matching seller is found. Sale price matching may continuously search for a matching product or seller over any time span. A buyer and seller may be enabled to complete a private transaction. Sale price matching may capture, catalog, store, retrieve, modify and update data about buyers or sellers.

### FIELD

This disclosure relates generally to sale price matching.

### BACKGROUND

A seller, such as a wholesaler or a retailer, may have inventory it wishes to sell at a discounted price, for example, if a product becomes overstocked or discontinued. A seller may have to conduct its own search for buyers and may risk devaluing its brand by selling at a discounted price. Buyers may wish to save time and resources spent continuously searching for a particular product at a desired price.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

The instant application discloses, among other things, sale price matching. In one embodiment, a software application or website may enable a buyer to enter search criteria for a product at a desired price and receive a notification when a matching seller is found. A seller may see the buyer's search criteria and make an offer. A buyer may accept or reject a seller's offer. Sale price matching may enable the buyer and seller to conduct a private transaction, which may enable a seller to maintain high brand value, for example. Sale price matching may capture, catalog, store, retrieve, modify and update data about buyers or sellers.

### BRIEF DESCRIPTION OF THE DRAWINGS

FIG. 1 is a flow diagram for a sale price matching service according to one embodiment.

FIG. 2 is a flow diagram for a sale price matching service according to another embodiment.

FIG. 3 illustrates a system capable of supporting a sale price matching service, according to one embodiment.

FIG. 4 is a component diagram of a computing device which may support a sale price matching service process according to one embodiment.

### DETAILED DESCRIPTION

Many of the attendant features may be more readily appreciated as they become better understood by reference to the following detailed description considered in connection with the attached drawings, in which like parts are assigned like numerals.

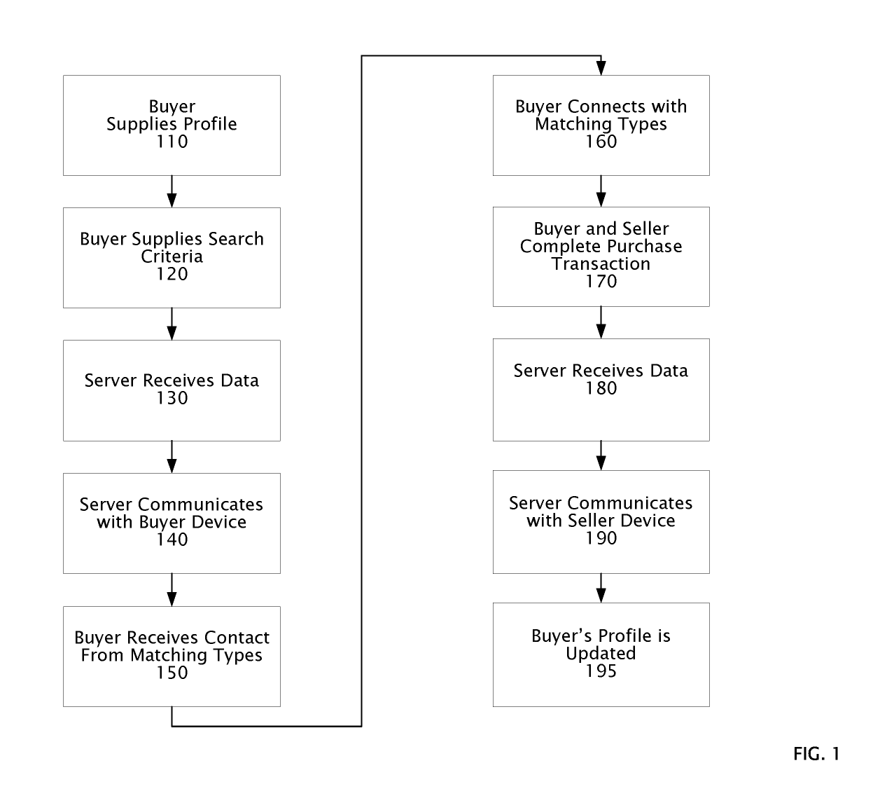

FIG. 1 is a flow diagram for a sale price matching process according to one embodiment. In one embodiment, a software application or website may enable a buyer to enter search criteria for a product at a desired price and receive a notification when a matching seller, who may be willing to sell the product at the buyer's desired price, is found. A product may comprise a good or service, for example. Sale price matching may continuously search for a matching seller for days, weeks, or months, or any duration set by a buyer or seller.

A buyer's search criteria may include a product description, brand, color, size, material, condition (such as new or used), environmental sustainability, place of origin, quantity, price, or other criteria for example. A buyer may also input a photo, video, audio, measurements, or other data in a product search. In another embodiment, a seller may search for a buyer looking to purchase a product.

Sale price matching may retrieve stock keeping unit codes (SKUs), Universal Product Codes (UPCs), brand names, model numbers, photos, videos, descriptions, or other product identifiers. Sales price matching may request the buyer to confirm that a retrieved product correctly matches the buyer's search criteria.

A seller may see the buyer's search criteria and offer to sell the product to the buyer at the desired price. A buyer may accept or reject a seller's offer. For example, the buyer may click “Buy” to accept. In another embodiment, a seller may choose to accept or reject a buyer's offer. A buyer or seller may also further negotiate terms of an offer or acceptance. If an offer is accepted, the product may be delivered.

Sale price matching may enable the buyer and seller to complete a private transaction which may be closed to the public. A private transaction may enable a seller to maintain high brand value, for example. Any part of sale price matching, including an offer, sale, exchange of information, or sales transaction, may be accessible only to the buyer and seller, or to a limited group, for example. Sale price matching may capture, catalog, store, retrieve, modify and update data about buyers or sellers, for example.

At Buyer Supplies Profile 110, a buyer may supply its profile description. At Buyer Supplies Search Criteria 120, a buyer may supply its products search criteria, desired units, and priority price range. For example, a buyer may seek to purchase a bicycle but only when it becomes available at a discounted price within the buyer's price range. The buyer's search criteria may be defined by various factors and priority values that may enable categorization of the product the buyer is shopping for.

A priority value may depend on the urgency level a buyer attaches to the purchase of a product. For example, a buyer may want to purchase a dress before attending a wedding. Once the wedding date is over, the buyer may want the search to expire, as she will not need to shop for dresses after that.

A buyer may define factors to be considered by a sale price matching service to determine when a match is found. These factors may include a desired price range per unit, number and detailed description of products or services the buyer is ready to purchase. For example, a buyer that is a discount clothing store may be interested in purchasing 5 dresses within a price range of $100 to $250 dollars for each unit.

At Server Receives Data 130, a device may store, catalog, sort, or modify data for the purpose of determining a classification of a relationship between buyers and sellers. In one embodiment, Server Receives Data 130 may store data used to determine a match for buyer's search criteria, such as units or price desired, and may store a match between a buyer and a seller ready to complete a sale.

At Server Communicates with Buyer Device 140, a buyer may be presented with a display representing a description of a seller ready complete a purchase. At Buyer Receives Contact From Matching Types 150, a buyer may find displayed a seller who initiated contact. At Buyer Connects with Matching Types 160, a buyer may proceed with connecting with the seller.

At Buyer and Seller Complete Purchase Transaction 170, a buyer may be enabled to upload payment information to the seller. At Server Receives Data 180, Server Receives Data 180 may receive a message indicating the buyer's order has been processed. At Server Communicates with Seller Device 190, in response to processed payment or other data captured, Server Communicates with Seller Device 190 may provide a website or communicate with an app on the seller's device, enabling a seller to perform an action, such as sending the buyer a sales receipt and request shipping address information. At Buyer's Profile is Updated 195, a buyer's profile may be updated to account for the completed product purchase.

Buyers may define their sale search criteria without regard to other buyer's sale search criteria. For example, Buyer A may be searching to buy an instance of Article A for a price within range X, whereas Buyer B may be searching for an instance of Article A for a price within range Y. Neither Buyer B nor Buyer A has access to the price information of the other, and no buyer can modify their offer price range in response to the offer price ranges of other buyers. A buyer may be a retail or wholesaler as well as an individual private party.

In another embodiment, sale price matching may include rating, scoring, or ranking for buyers or sellers.

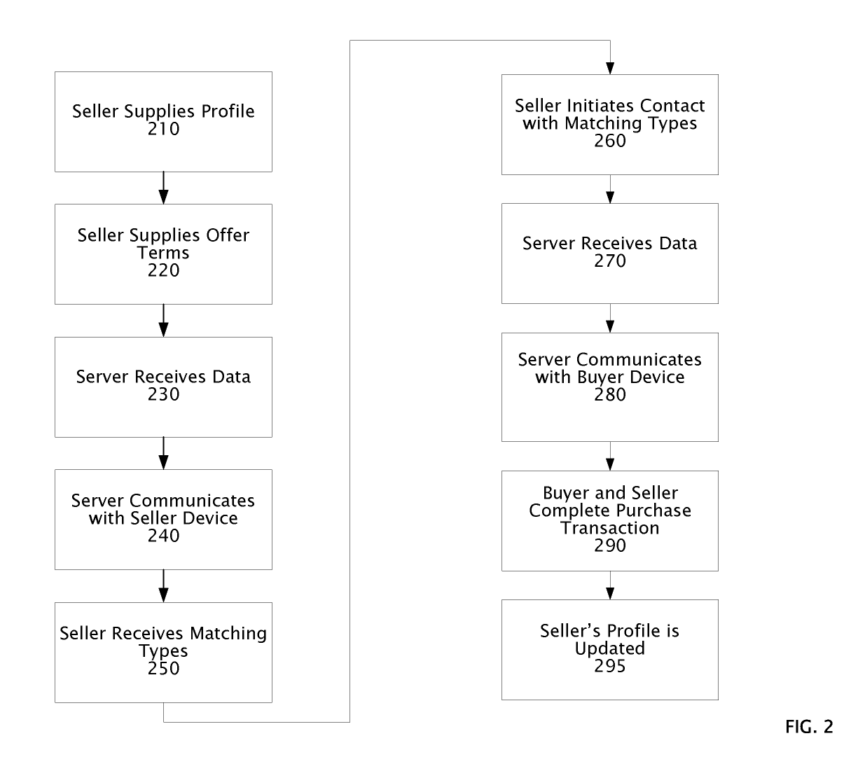

FIG. 2 is a flow diagram for a sale price matching service process according to another embodiment. At Seller Supplies Profile 210, a seller may supply its profile description. At Seller Supplies Offer Terms 220, a seller may provide a description, priority price range, or units available for sale at a discounted price. For example, a seller may wish to commit to selling as many skis and ski waxing services as are needed before ski season ends. A seller's offer terms may be defined by factors and priority values that may enable categorization of their products and services.

A priority value may depend on the urgency level a seller attaches to the sale of a product, for example. A seller may define other factors to be considered by a sale price matching service to determine when a match is found. Such factors may include the price range per unit, number and detailed description of products or services a seller is ready to sell. For example, where a seller is interested in selling 100 sets of skis for an amount within price range for each set of $100 to $150 dollars, and there is a buyer searching for 75 sets of skis with purchasing price range for each set of $75 to $99 and another buyer searching for 25 sets of with purchase price for each set of $100 to $125. With respect to these two buyers, they may be categorized and paired together for the seller to complete a sale.

At Server Receives Data 230, a device may store, catalog, sort, or modify data for the purpose of determining a classification of a relationship between entities and buyers. In one embodiment, Server Receives Data 230 may store data used to determine a match for seller's offer terms or hierarchy of prices pertaining to a quantity of products or services described in seller's offer terms, and then a match of a seller with a buyer or buyers that are ready to complete a purchase.

At Server Communicates with Seller Device 240, a user may be presented with a display representing descriptions of buyers which may provide the user with a basis for her to select which buyer or buyers to select. For example, the user may find a buyer whose interest aligns with their offer terms and select the action to initiate contact with that particular buyer.

In another embodiment, a user may enter a URL to access a sale price matching service. At Server Receives Data 230, Server Receives Data 230 may receive a message indicating the user's location. At Server Communicates with Seller Device 240, in response to the location or other data captured, Server Communicates with Seller Device 240 may provide a website or communicate with an app on the user's device, enabling a user to perform an action, such as selecting, searching, or entering other offer terms. At Seller Receives Matching Types 250, the buyers that match up with the seller's offer terms may be represented in a display to the seller.

At Seller Initiates Contact with Matching Types 260, a seller may be enabled to remotely initiate contact with an online buyer and connect with the online buyer. At Buyer and Seller Complete Purchase Transaction 270, the buyer may be enabled to upload payment information to the seller. At Server Receives Data 280, Server Receives Data 280 may receive a message indicating buyer's payment has been processed. At Server Communicates with Buyer Device 290, in response to processed payment or other data captured, Server Communicates with Buyer Device 290 may provide a website or communicate with an app on the buyer's device, enabling a buyer to perform an action, such as selecting or entering shipping address information. At Seller Profile is Updated 295, Seller Profile is Updated 295 may modify seller's profile to account for the completed sales transaction.

Multiple units of a product may be sold by one or more sellers, and multiple buyers may shop for a product. Sale price for each product unit may vary according to sale terms the seller defines. Buyers may define their search criteria without knowing another buyer's search criteria. For example, Buyer A may be searching to buy a unit of Article A for a price within range X, whereas Buyer B may be searching for a unit of Article A for a price within range Y. Buyer B and Buyer A may not have access to the price information of the other, and may not modify their desired price range in response to that of the other buyer.

A seller may find a match with a buyer or set of buyers searching for multiple copies of one product, or for a variety of products or services. For example, an online musical instrument store using a sale price matching system may connect with various buyers who are offering to pay an acceptable price for one or more of the online music instrument store's flutes or trumpets. In some cases, a buyer may be a store, and may be looking for larger volumes of products or services to resell.

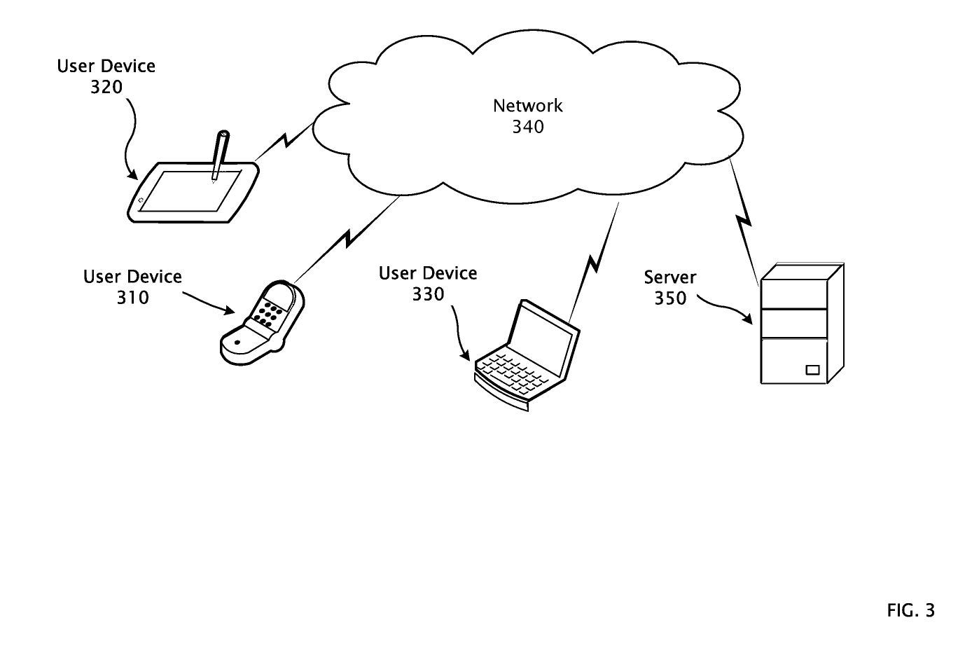

FIG. 3. is a block diagram illustrating an example of a system capable of supporting a Sale Price Matching Service, according to one embodiment. Network 340 may include Wi-Fi, cellular data access methods, such as 3G or 4GLTE, Bluetooth, Near Field Communications (NFC), the internet, local area networks, wide area networks, or any combination of these or other means of providing data transfer capabilities. In one embodiment, Network 340 may comprise Ethernet connectivity. In another embodiment, Network 340 may comprise fiber optic connections.

User Device 310, 320, or 330 may be a smartphone, tablet, laptop computer, smartwatch or intelligent eyewear, or other device, and may have location-based services, for example, GPS, cell phone tower triangulation capability, or accelerometers, and may have network capabilities to communicate with Server 350. Server 350 may include one or more computers, and may serve a number of roles. Server 350 may be conventionally constructed, or may be of a special purpose design for processing data obtained from a sale price matching service. One skilled in the art will recognize that Server 350 may be of many different designs and may have different capabilities.

User Device 310, 320, or 330 may include device application to support sale price matching, for example, allowing a user to request an action such as enter values, or make a selection. In another embodiment, User Device 310, 320, or 330 may display a website hosted on Server 350 in a browser, which may allow a user to request an action.

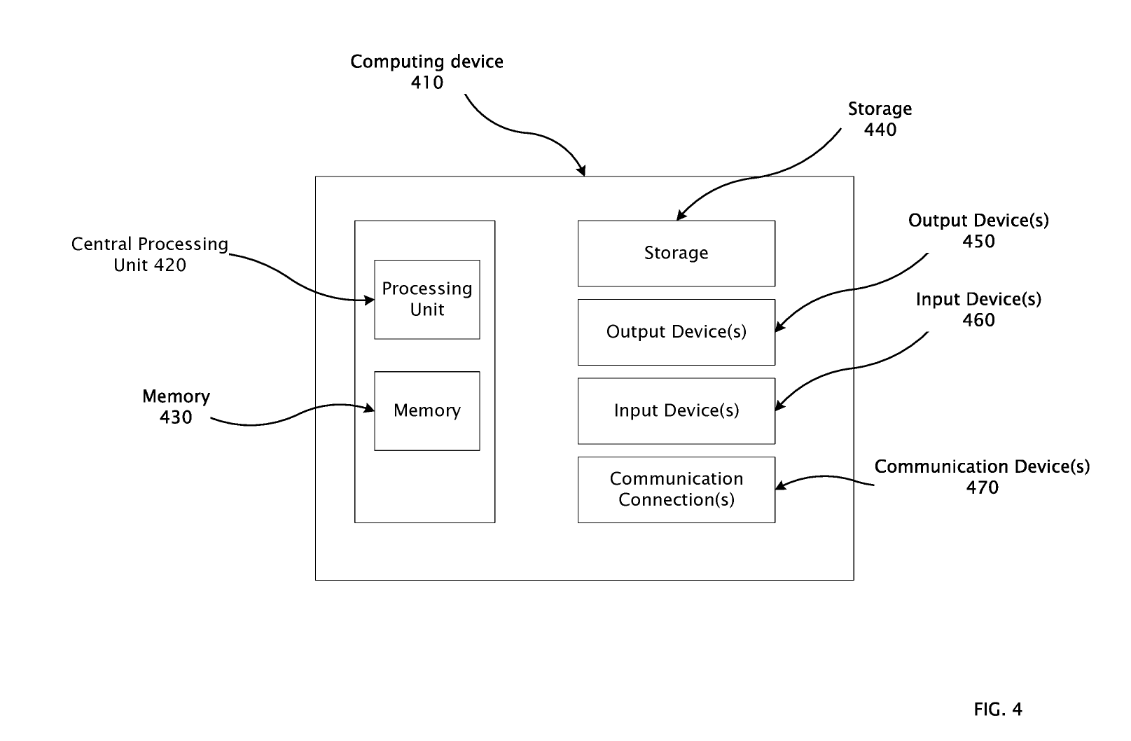

FIG. 4 is a component diagram of a computing device which may support a sales price matching service process according to one embodiment. Computing Device 410 can be utilized to implement one or more computing devices, computer processes, or software modules described herein, including, for example, but not limited to a mobile device. In one example, Computing Device 410 can be used to process calculations, execute instructions, and receive and transmit digital signals. In another example, Computing Device 410 can be utilized to process calculations, execute instructions, receive and transmit digital signals, receive and transmit search queries and hypertext, and compile computer code suitable for a mobile device. Computing Device 410 can be any general or special purpose computer now known or to become known capable of performing the steps or performing the functions described herein, either in software, hardware, firmware, or a combination thereof.

In its most basic configuration, Computing Device 410 typically includes at least one Central Processing Unit (CPU) 420 and Memory 430. Depending on the exact configuration and type of Computing Device 410, Memory 430 may be volatile (such as RAM), non-volatile (such as ROM, flash memory, etc.) or some combination of the two. Additionally, Computing Device 410 may also have additional features/functionality. For example, Computing Device 410 may include multiple CPU's. The described methods may be executed in any manner by any processing unit in computing device 410. For example, the described process may be executed by both multiple CPUs in parallel.

Computing Device 410 may also include additional storage (removable or non-removable) including, but not limited to, magnetic or optical disks or tape. Such additional storage is illustrated by Storage 440. Computer readable storage media includes volatile and nonvolatile, removable and non-removable media implemented in any method or technology for storage of information such as computer-readable instructions, data structures, program modules or other data. Memory 430 and Storage 440 are all examples of computer-readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 410. Any such computer readable storage media may be part of computing device 410. But computer readable storage media does not include transient signals.

Computing Device 410 may also contain Communications Device(s) 470 that allow the device to communicate with other devices. Communications Device(s) 470 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer-readable media as used herein includes both computer readable storage media and communication media. The described methods may be encoded in any computer-readable media in any form, such as data, computer-executable instructions, and the like.

Computing Device 410 may also have Input Device(s) 460 such as a keyboard, mouse, pen, voice input device, touch input device, etc. Output Device(s) 450 such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above-described logic and still conform to the described embodiments. Further, operations described herein may occur sequentially, or certain operations may be processed in parallel. Yet further operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention. Since many embodiments of the invention can be made without departing from the spirit and scope of the invention, the invention resides in the claims hereinafter appended.

1. A computer-operable method for sale price matching, comprising steps of:
receiving a buyer's input of product search criteria;
searching for products matching buyer's product search criteria;
retrieving product identifiers;
requesting confirmation that a product identifier correctly matches the buyer's product search criteria;
receiving confirmation that a product identifier correctly matches buyer's product search criteria;
displaying the buyer's product search criteria to be viewable by a seller;
enabling the seller to send the buyer an offer for sale;
receiving acceptance or rejection of the offer;
facilitating private exchange of information between the buyer and the seller;
facilitating a private sales transaction;
facilitating delivery of a product; and
capturing, cataloging, storing, retrieving, modifying, or updating data entered by the buyer or seller.

2. The computer-operable method of claim 1, wherein a buyer's product search criteria includes terms from the list containing product name, product description, brand, size, color, material, condition, sustainability, place of origin, quantity, and price.

3. The computer-operable method of claim 1, wherein the product identifier includes terms from the list containing product name, product description, brand, model number, photos, videos, Stock Keeping Unit (SKU) code, Universal Product Code (UPC), European Article Number (EAN), International Standard Book Number (ISBN), Quick Response (QR) code, or barcode.

4. The computer-operable method of claim 1, further comprising a buyer rating system.

5. The computer-operable method of claim 1, further comprising a seller rating system.
